(19) United States
(12) Patent Application Publication
(10) Pub. No.: US 2019/0278574 A1
(43) Pub. Date: Sep. 12, 2019

(54) TECHNIQUES FOR TRANSFORMING SERIAL PROGRAM CODE INTO KERNELS FOR EXECUTION ON A PARALLEL PROCESSOR

(71) Applicant: NVIDIA CORPORATION, Santa Clara, CA (US)

(72) Inventors: Mahesh RAVISHANKAR, Kenmore, WA (US); Vinod GROVER, Mercer Island, WA (US); Evghenii GABUROV, Santa Clara, CA (US)

(21) Appl. No.: 16/215,488

(22) Filed: Dec. 10, 2018

Related U.S. Application Data
(60) Provisional application No. 62/641,193, filed on Mar. 9, 2018.

(51) Int. Cl. G06F 8/41; G06F 16/901; G06F 9/52

(52) U.S. Cl. CPC G06F 8/445; G06F 9/52; G06F 16/9024

(57) ABSTRACT

A compiler generates an accelerated version of a serial computer program that can be executed on a parallel processor. The compiler analyzes the serial computer program and generates a graph of nodes connected by edges. Each node corresponds to an operation or value set forth in the serial computer program. Each incoming edge corresponds to an operand that is specified or generated in the serial computer program. The compiler partitions the graph of nodes into two different types of partitions; a first type of partition includes one or more nodes that correspond to one or more pointwise operations, and a second type of partition includes one node that corresponds to one operation that is performed efficiently via a library. For each partition, the compiler configures a sequence of kernels that can be executed on the parallel processor to perform the operations associated with the computer program in an accelerated fashion.

### CROSS-REFERENCE TO RELATED APPLICATIONS

This application claims priority benefit of the U.S. Provisional Patent Application titled, “Fusion and Partitioning in Grumpy Directed Acyclic Graph,” filed on Mar. 9, 2018 and having Ser. No. 62/641,193. The subject matter of this related application is hereby incorporated herein by reference.

### BACKGROUND

A serial processor executes operations set forth in a serial computer program in a sequential manner. For example, a central processing unit (CPU) could execute a first operation set forth in the serial computer program and subsequently the CPU could execute a second operation set forth in the serial computer program. A parallel processor, on the other hand, executes operations set forth in a parallel computer program in a parallel manner. For example, a parallel processing unit (PPU) could simultaneously execute a first operation and a second operation set forth in the parallel computer program. Because parallel processors can execute multiple operations concurrently, parallel processors can perform some operations faster and more efficiently than serial processors. However, serial computer programs written for serial processors usually cannot be executed on parallel processors. Consequently, such computer programs usually cannot be accelerated using parallel processors.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A illustrates a system configured to implement one or more aspects of the various embodiments.

FIG. 1B illustrates a mapping between the nodes, partitions, and kernels of FIG. 1A, according to various embodiments.

FIGS. 2A-2B illustrate an example of how the compiler of FIG. 1 generates and partitions a graph of nodes based on program code, according to various embodiments.

FIGS. 3A-3C illustrate how the compiler of FIG. 1 generates and partitions a graph of nodes differently based on different operations, according to various embodiments.

FIG. 4 is a flow diagram of method steps for converting program code into a sequence of kernels, according to various embodiments.

FIG. 5 is a block diagram illustrating a computer system configured to implement one or more aspects of various embodiments.

FIG. 6 is a block diagram of a parallel processing unit (PPU) included in the parallel processing subsystem of FIG. 5, according to various embodiments.

FIG. 7 is a block diagram of a general processing cluster (GPC) included in the parallel processing unit (PPU) of FIG. 6, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As noted above, serial processors execute operations set forth in serial computer programs in a sequential manner, while parallel processors execute operations set forth in parallel computer programs in a parallel manner. Accordingly, a serial processor generally executes a set of operations more slowly than a parallel processor can execute the same set of operations, provided at least some of those operations can be executed simultaneously and independently of one another on the parallel processor.

Oftentimes computer programs are designed and written for execution on a serial processor during development and then subsequently re-written for faster execution on a parallel processor. For example, a computer programmer could initially develop a computer program that executes efficiently on a serial processor when processing a small sample dataset. Subsequently, the computer programmer could rewrite the computer program to also execute efficiently on a parallel processor when a processing a much larger dataset that cannot be processed efficiently on the serial processor.

One drawback of the approach described above is that re-writing a serial computer program for parallel execution can be tedious, especially with large and complex computer programs. Another drawback of the approach described above is that re-writing serial computer programs for parallel execution oftentimes requires specialized knowledge of the underlying parallel processing hardware. Accordingly, what is needed in the art is a technique for automatically converting serial computer programs to parallel computer programs for accelerated execution on a parallel processor.

To address this need, various embodiments include a compiler that generates an accelerated version of a serial computer program that can be executed on a parallel processor. In one embodiment, the compiler analyzes the serial computer program and generates a graph of nodes connected by edges. Each node corresponds to an operation or a value set forth in the serial computer program. Each incoming edge corresponds to an operand that is specified or generated in the serial computer program. The compiler partitions the graph of nodes into two different types of partitions.

In one embodiment, a first type of partition includes one or more nodes that correspond to one or more pointwise operations, and a second type of partition includes one node that corresponds to one operation that is performed efficiently via a library. For a partition having the first type, the compiler generates a kernel that can perform all of the pointwise operations on the parallel processor without needing to move data into and out of register memory excessively. For a partition having the second type, the compiler generates a library call to invoke execution of a kernel that can perform the operation associated with the partition. In the manner described above, in various embodiments the compiler configures a sequence of kernels that can be executed on the parallel processor to perform the various operations associated with the computer program in an accelerated fashion.

At least one technological advantage of the techniques described herein is that a serial computer program designed for serial execution can be automatically converted into a parallel computer program that is optimized for parallel execution. Accordingly, serial computer programs can quickly and easily be accelerated via parallel processing hardware. Another technological advantage is that specialized knowledge of parallel processors is not needed. These technological advantages represent multiple technological advancements relative to prior art approaches.

### System Overview

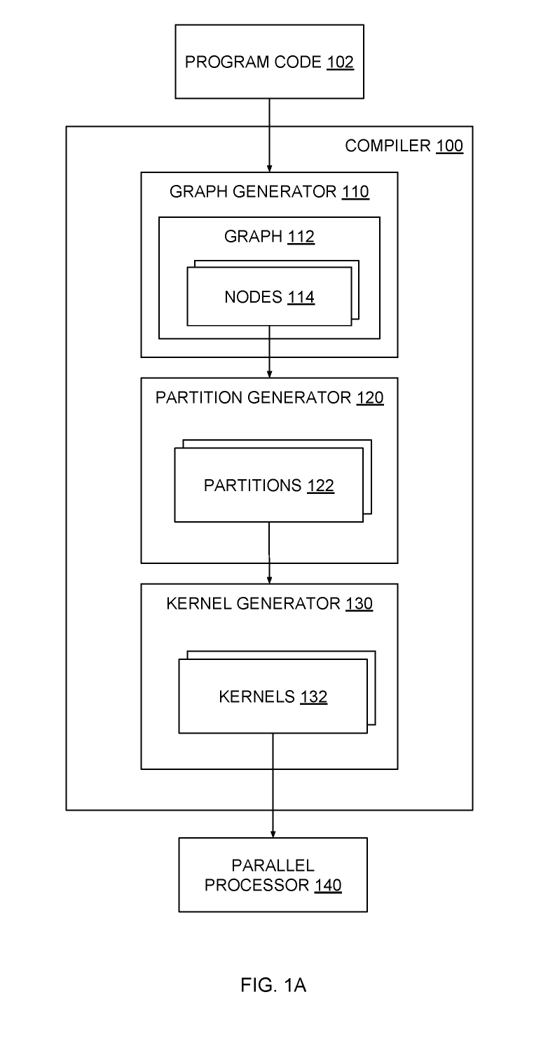

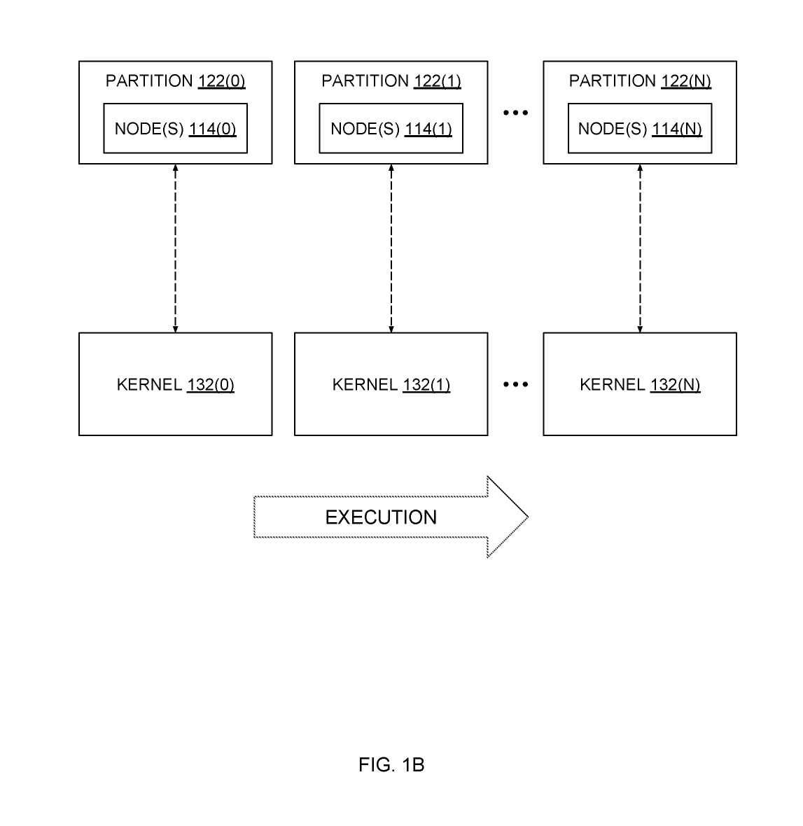

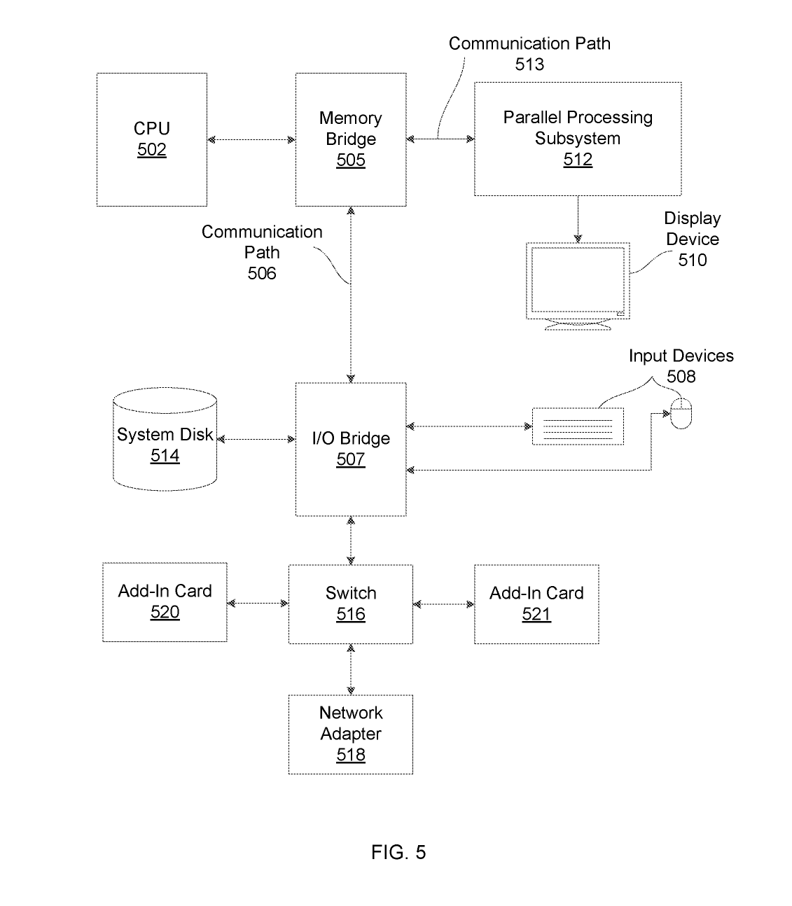

FIG. 1A illustrates a system configured to implement one or more aspects of the various embodiments. As shown, in one embodiment, a compiler 100 includes a graph generator 110, a partition generator 120, and a kernel generator 130. Graph generator 110 processes program code 102 to generate a graph 112 of one or more nodes 114. Partition generator 120 processes graph 112 to generate partitions 122. Kernel generator 130 processes partitions 122 to generate kernels 132. Kernels 132 can be executed by a parallel processor 140. An example of a parallel processor is described in greater detail below in conjunction with FIGS. 5-7.

In one embodiment, program code 102 includes a sequence of instructions that, when executed by a serial processor, performs one or more operations serially. For example, program code 102 could include a sequence of matrix transformations that the serial processor performs sequentially. A central processing unit (CPU) is one example of a serial processor. In one embodiment, compiler 100 executes on a CPU, such as that shown in FIG. 5.

In one embodiment, graph 112 is a graphical representation of program code 102 and graph generator 110 performs a static and/or dynamic analysis of program code 102 to generate graph 112. The graphical representation of program code 102 includes a different node 114 for each operation or value set forth in program code 102 and a different incoming edge for each operand specified in or generated via program code 102. Accordingly, each node 114 may correspond to a different portion of program code 102. A directed acyclic graph is one example of a graphical representation of program code.

In one embodiment, each partition 122 includes one or more nodes 114 derived from graph 112, and partition generator 120 traverses graph 112 to assign nodes 114 to different partitions 122. When traversing graph 112 in this manner, partition generator 120 selects a node associated with one or more subgraphs of graph 112. Partition generator 120 traverses nodes 114 within a given subgraph and accumulates one or more nodes 114 to a common partition when those nodes correspond to operations that can be combined with one another and executed in a single kernel 132. Such nodes and corresponding operations may be referred to herein as being “fusable.” Partition generator 120 also assigns any one node to a dedicated partition when that node corresponds to an operation that cannot be combined with other operations. Such nodes and corresponding operations may be referred to herein as being “non-fusable.” Via many such traversals, partition generator 122 generates an ordered sequence of partitions 122.

In one embodiment, a “fusable” node corresponds to a pointwise operation, such as a unary or binary operation, where the value of each element of a result tensor depends on the value of a single element of each input tensor. Sin, cos, tan, exp, and log are examples of unary pointwise operations. Add, subtract, multiple, divide are examples of binary pointwise operations. Multiple pointwise operations corresponding to multiple fusable nodes may be performed by one kernel 132.

In one embodiment, a “non-fusable” node corresponds to an operation where the value of one or more elements in a result tensor depends on the value of multiple elements of each input tensor. Matrix-vector-multiply, matrix-matrix-multiply, convolution, and reduction are examples of such operations. In another embodiment, a non-fusable node corresponds to a pointwise operation that cannot be combined with any operations associated with any adjacent nodes. An operation corresponding to a non-fusable node may be performed by a dedicated kernel 132 derived from a library, such as Compute Unified Device Architecture (CUDA) Basic Linear Algebra (BLAS) library (also known as cuBLAS) or the CUDA Deep Neural Network (DNN) library (also known as cuDNN).

In one embodiment, a node may be determined to be fusable or non-fusable based on a number of outputs from an operation associated with the node that depend on a single input to the operation.

In one embodiment, for a partition 122 that includes multiple fusable nodes, kernel generator 130 generates a kernel 132 to perform the multiple operations associated with those nodes. One advantage of performing multiple operations via one kernel 132 is that data associated with the multiple operations need only be written to register memory of parallel processor 140 once when the one kernel 132 is initially launched. This approach advantageously reduces register memory transactions compared to implementations that launch multiple kernels to perform multiple operations and perform a different set of register memory transactions for each kernel.

In one embodiment, for a partition 122 that includes one non-fusable node, kernel generator 130 retrieves an appropriate kernel 132 from a library of kernels to perform the operation associated with the node or generates the kernel if none are available. One advantage of performing an operation via a kernel derived from a library of kernels is that the operation may have a highly efficient library implementation.

In various embodiments, each kernel 132 corresponds to a different partition 122, and kernel generator 130 configures each kernel 132 based on the corresponding partition 122 and associated set of nodes 114, as also shown in FIG. 1B.

FIG. 1B illustrates a mapping between the nodes, partitions, and kernels of FIG. 1A, according to various embodiments. As shown, partition 122(0) includes node(s) 114(0) and corresponds to kernel 132(0), partition 122(1) includes node(s) 114(1) and corresponds to kernel 132(1), and partition 122(N) includes node(s) 114(N) and corresponds to kernel 132(N). A given partition 122 includes either multiple fusable nodes 114 or one non-fusable node 114. A given kernel 132 that corresponds to the given partition 122 can be executed by parallel processor 140 to perform multiple operations when the given partition 122 includes multiple fusable nodes 114. Alternatively, a given kernel 132 that corresponds to the given partition 122 can be executed by parallel processor 140 to perform one operation when the given partition 122 includes one non-fusable node 114.

In one embodiment, parallel processor 140 executes kernels 132 in an order that is derived from the sequential ordering of partitions 122, as is shown. For example, parallel processor 140 could load data associated with kernel 132(0) into register memory and then execute kernel 132(0) with the loaded data to perform one or more operations associated with node(s) 114(0). Subsequently, parallel processor 140 would load data associated with kernel 132(1) into register memory and then execute kernel 132(1) with the loaded data to perform one or more operations associated with node(s) 114(1). In this embodiment, parallel processor 140 sequentially executes kernels 132 in order to perform all operations originally set forth in program code 102.

Referring generally to FIGS. 1A-1B, in various embodiments, compiler 100 advantageously accelerates performance of the operations set forth in program code 102 by leveraging the parallel execution capabilities of parallel processor 140. In particular, compiler 100 configures kernels 132 for execution on parallel processor 140 in order to perform accelerated versions of those operations. In addition, compiler 100 coalesces multiple operations together for execution by one kernel 132 to more efficiently utilize memory resources of parallel processor 140. Specifically, fusing multiple nodes 114 included in one partition 122 to combine the associated operations reduces register memory transactions. Prior art implementations do not combine operations in this manner and rely on multiple global memory transactions, thereby incurring latency.

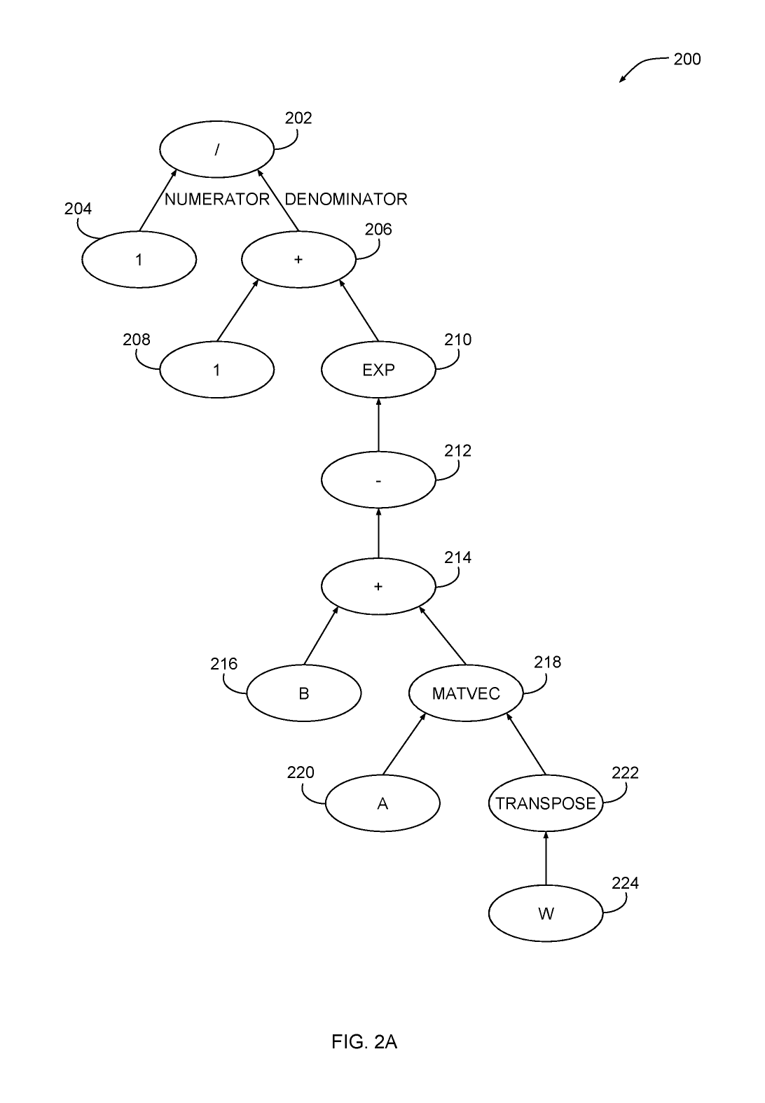

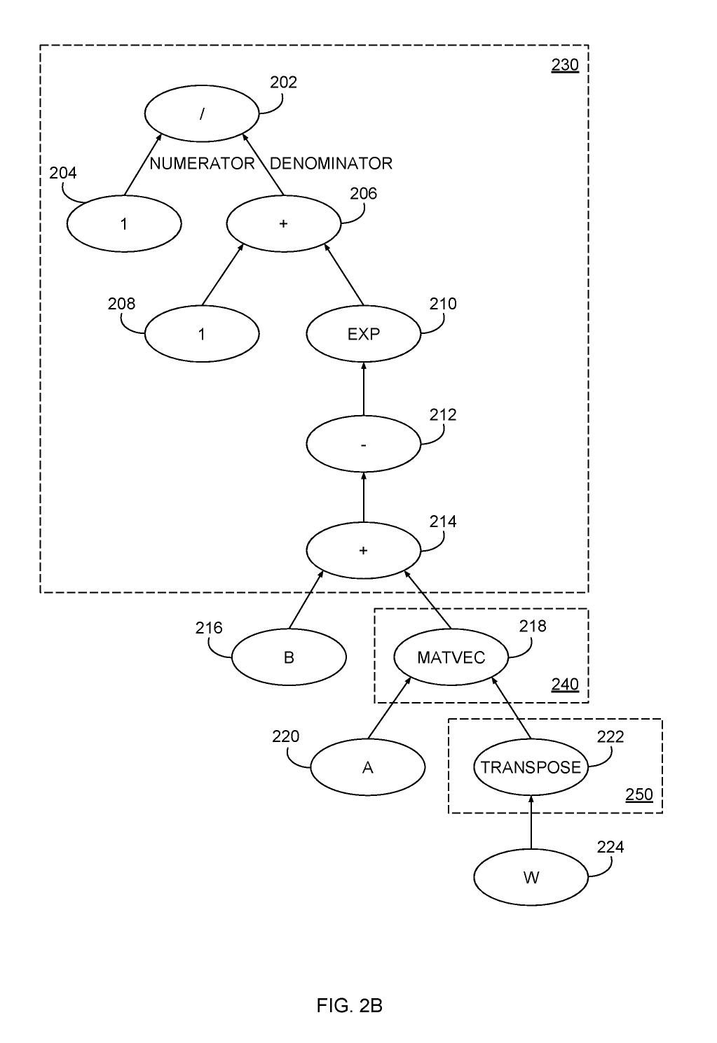

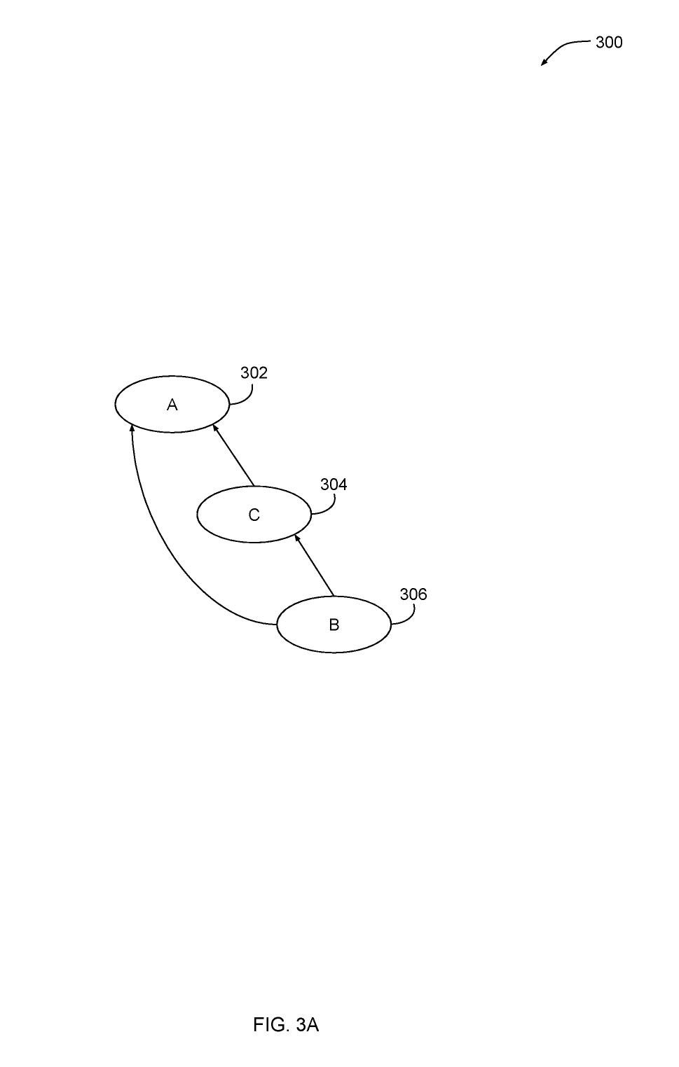

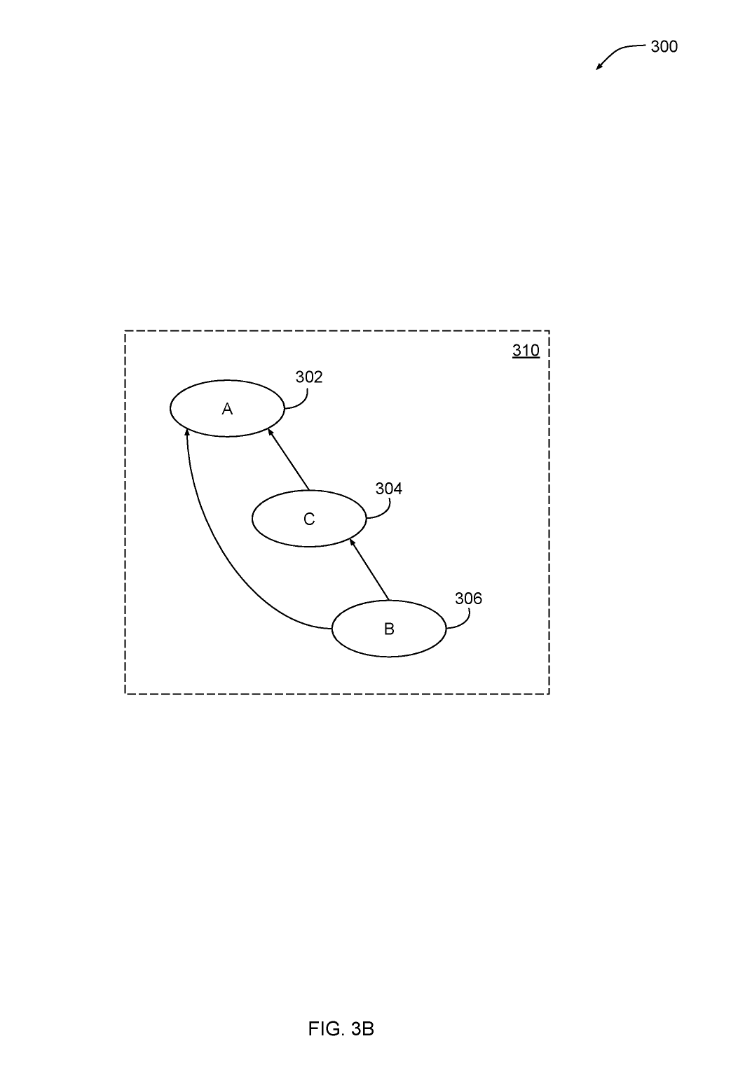

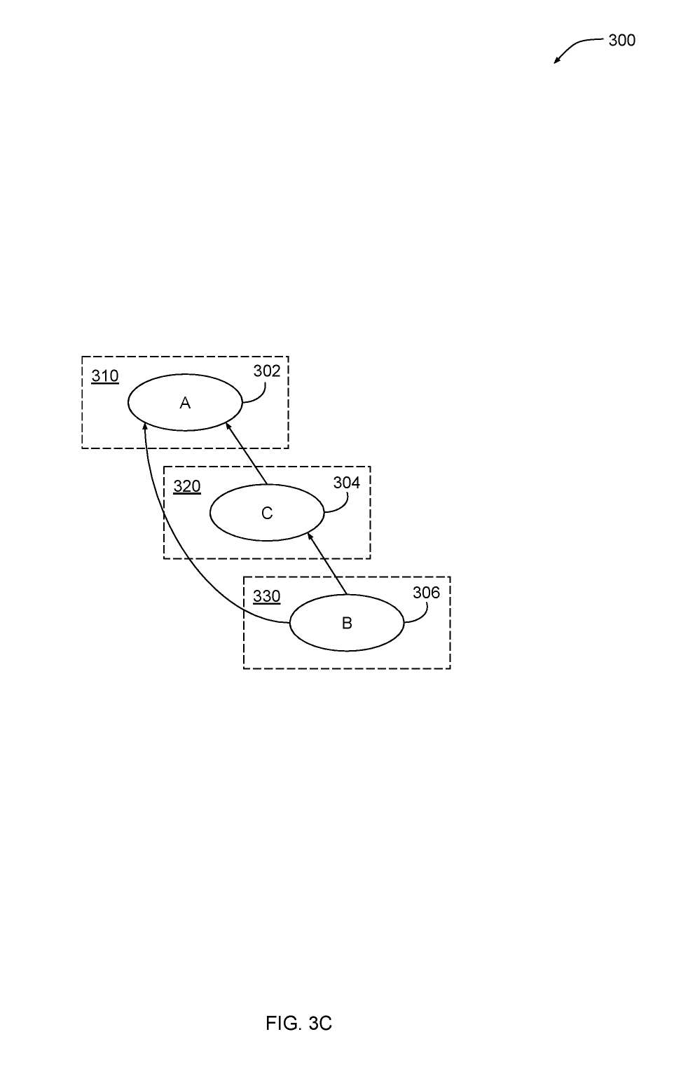

FIGS. 2A-3D set forth various examples of how compiler 100 generates a graph representation of program code 102, partitions the graph representation, and generates kernels for execution based on the partitioned graph representation, according to various embodiments.

### Example Graph Partitioning

FIGS. 2A-2B illustrate an example of how the compiler of FIG. 1 generates and partitions a graph of nodes based on program code, according to various embodiments. The program code discussed in conjunction with the example shown in FIGS. 2A-2B is listed below:

Listing 1

1. import numpy as np
2. W = np.array([.., ..], np.float32)
3. a = np.array([..], np.float32)
4. b = np.array([..], np.float32)
5. x = np.transpose(W).dot(a) + b
6. output = 1.0/(1.0 + np.exp(−x));

In one embodiment, Listing 1 sets forth example program code written in the Python programming language. The example program code creates variables W, a, b, and x (a matrix and three arrays, respectively) and then evaluates an expression based on these variables, setting the result to the variable output. The example program code of Listing 1 can be executed by a serial processor. However, when W, a, b, and x have very large dimensions, the computation of output may take an excessive amount of time. In this situation, compiler 100 can be implemented to analyze this example program code and generate a graph of nodes, as shown in FIG. 2A.

Referring now to FIG. 2A, in one embodiment, compiler 100 generates graph 200 based on the example program code shown in Listing 1. As shown, graph 200 includes nodes 202, 204, 206, 208, 210, 212, 214, 216, 218, 220, 222, and 224 connected by various edges. A given node of graph 200 corresponds to an operation or a value specified in the example program code. A given incoming edge of graph 200 corresponds to an operand specified in or generated via the program code. In one embodiment, graph 200 is a directed acyclic graph.

In one embodiment, the nodes of graph 200 are coupled together via edges to represent that some nodes receive input from other nodes. For example, node 214 (representing an addition operation) receives input from node 216 (representing the value of b) and node 218 (representing the output of a dot product between the transpose of W and a) via the edges shown. Node 214 computes the sum of the outputs of nodes 216 and node 218. Persons familiar with computer programming and graph theory will also recognize that numerous techniques exist for generating graphs, such as graph 200, based on program code, such as the example program code shown in Listing 1.

In one embodiment, graph generator 110 of FIG. 1A analyzes the example program code and generates graph 200 in the manner described previously in conjunction with FIGS. 1A-1B. Subsequently, partition generator 120 of FIG. 1A partitions graph 200 to generate a set of partitions, as shown in FIG. 2B.

Referring now to FIG. 2B, in one embodiment, partition generator 120 generates partitions 230, 240, and 250 when partitioning graph 200. As shown, partition 230 includes nodes 202, 204, 206, 208, 210, 212, and 214, partition 240 includes node 218, and partition 250 includes node 222.

In various embodiments, partition generator 120 includes different nodes in different partitions based whether those nodes are fusable or non-fusable. For example, partition generator 120 could include nodes 202, 204, 206, 208, 210, 212, and 214 in partition 230 because the operations associated with nodes 202, 206, 210, 212, and 214 can be coalesced into one kernel 132. Nodes 204 and 208 represent scalar values that can also be coalesced to that kernel 132. Similarly, partition generator 120 includes nodes 218 and 222 in partitions 240 and 250, respectively, because the matrix-vector multiple and transpose operations associated with those nodes can be efficiently implemented via kernels included in libraries.

In one embodiment, a node may be determined to be fusable or non-fusable based on a number of outputs from an operation associated with the node that depend on a single input to the operation

In one embodiment, partition generator 120 traverses graph 200 starting from the root node (node 202) and progressing downwards across the various predecessor nodes of node 202. In so doing, partition generator 120 may recursively visit successive predecessor nodes in any given subgraph of graph 200 and accumulate predecessor nodes to a common partition when those nodes are fusable, and generate dedicated partitions for nodes that are not fusable.

In one embodiment, kernel generator 130 analyzes graph 200 and configures a different kernel for each of partitions 230, 240, and 250. In particular, kernel generator 130 generates a kernel 132 that performs the various operations associated with the nodes included in partition 230. In addition, kernel generator 130 configures kernels that are derived from a library of kernels to perform the operations associated with partitions 240 and 250, respectively. The kernels generated in this fashion can then be executed by parallel processor 140 to perform the operations set forth in the example program code of Listing 1 in an accelerated manner and with efficient memory utilization.

In one embodiment, when generating partitions, partition generator 120 may encounter nodes that should be fusable but cannot be fused with any adjacent nodes. For example, node 222 included in partition 250 could be a pointwise operation that should be combined with another pointwise operation associated with an adjacent node, if any such node were present. However, the only adjacent node associated with an operation (node 218) is non-fusable and so node 222 is included in a dedicated partition. As a general matter, partition generator 120 partitions any given graph differently depending on the operations associated with the given graph, as described in greater detail below in conjunction with FIGS. 3A-3C.

FIGS. 3A-3C illustrate how the compiler of FIG. 1 generates and partitions a graph of nodes differently based on different operations, according to various embodiments. As shown in FIG. 3A, in one embodiment, a graph 300 includes nodes 302, 304, and 306. Graph generator 120 may generate graph 300 based on program code (none shown) that specifies three operations A, B, and C. Partition generator 120 may then partition graph 300 differently depending on whether the operations associated with nodes 302, 304, and 306 are fusable or non-fusable, as described below in conjunction with FIGS. 3B and 3C.

Referring now to FIG. 3B, in one embodiment, partition generator 120 determines that nodes 302, 304, and 306 can be fused and then generates partition 310 to include all of those nodes. In so doing, partition generator 120 initially analyzes node 302. Since node 302 is the root node, partition generator creates a new partition and adds node 302 to that partition. Partition generator 120 then traverses graph 300 to the predecessors of node 302, nodes 304 and 306. Partition generator 120 analyzes nodes 304 and 306 and determines that operations B and C can be fused with operation A, and then adds nodes 304 and 306 to partition 310. The process described in this embodiment differs when some of nodes 302, 304, and 306 are non-fusable, as described in greater detail below in conjunction with FIG. 3C.

Referring now to FIG. 3C, in one embodiment, partition generator 120 determines that nodes 302, 304, and 306 cannot be fused and then generates partitions 310, 320, and 330 that are dedicated to those nodes, respectively. In so doing, partition generator 120 initially analyzes node 302. Because node 302 is the root node, partition generator creates a new partition and adds node 302 to that partition. Partition generator 120 then traverses graph 300 to the predecessors of node 302, nodes 304 and 306. Partition generator 120 analyzes node 306 and determines that operation C should be executed by a kernel derived from a library. Accordingly, partition generator 120 places node 306 into a dedicated partition, partition 330. In conjunction, partition generator 120 analyzes node 304 and determines that node 304 generates output that is needed by node 306. Accordingly, partition generator 120 places node 304 into a dedicated partition, partition 320.

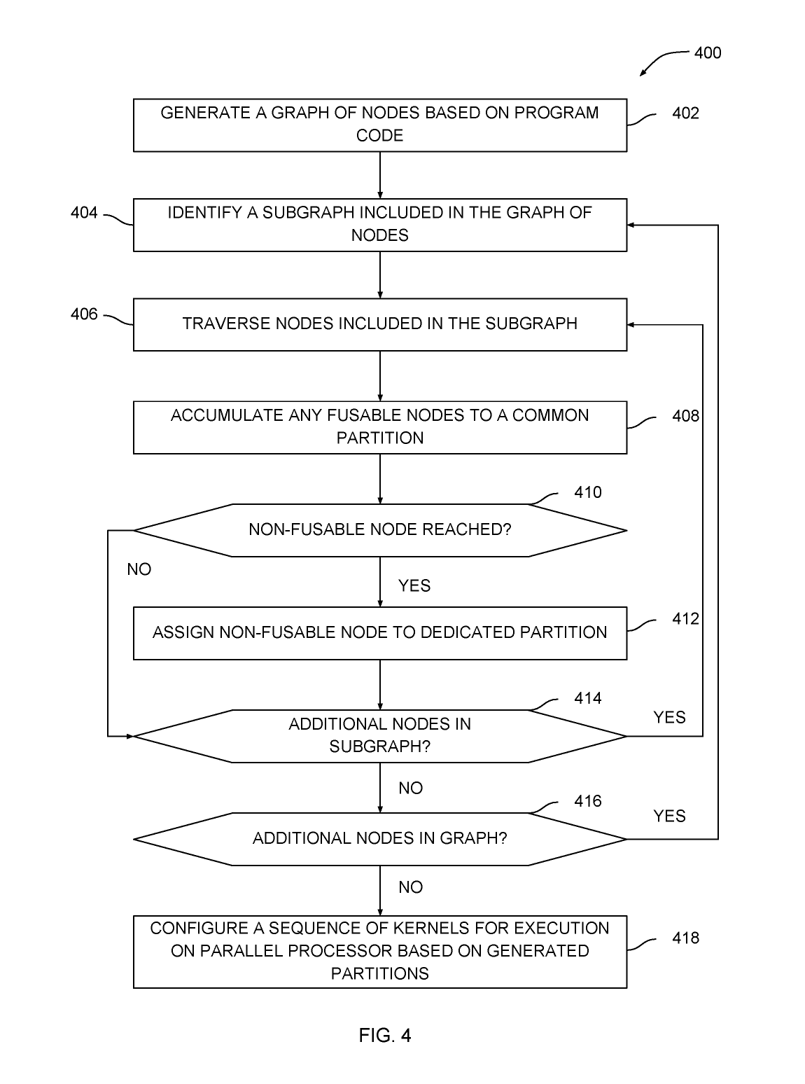

In various embodiments, partition generator 120 generates disjoint partitions in a manner that avoids cyclic dependencies between those partitions. When analyzing a given root node, partition generator 120 may collect a given predecessor to which the root node has a transitive dependence to a given partition if the predecessor node has not already been collected to another partition. Persons skilled in the art will understand that partition generator 120 in particular, and compiler 100 in general, can implement any technically feasible approach to performing the various techniques described above, and that the foregoing description is not meant to limit the possible practical implementations of compiler 100. Various operations performed when compiler 100 generates kernels 132 for execution are described in greater detail below in conjunction with FIG. 4.

### Transforming Program Code Into Kernels

FIG. 4 is a flow diagram of method steps for converting program code into a sequence of kernels, according to various embodiments. Although the method steps are described in conjunction with the systems of FIGS. 1-3C, persons skilled in the art will understand that any system configured to perform the method steps in any order falls within the scope of the present embodiments.

As shown, a method 400 begins at step 402, where graph generator 110 within compiler 100 generates a graph of nodes based on program code 102. In one embodiment, the program code includes a sequence of instructions that can be executed by a serial processor, such as a CPU, to perform one or more operations serially. In another embodiment, when generating the graph of nodes graph generator 110 generates a graphical representation of the program code that includes a different node for each operation or value set forth in the program code and a different incoming edge for each operand specified in or generated via the program code. A directed acyclic graph is one example of a graphical representation of program code.

At step 404, partition generator 120 identifies a subgraph included in the graph of nodes generated at step 402. In one embodiment, a given subgraph included in the graph of nodes includes a root node and one or more predecessor nodes of the root node. In another embodiment, the subgraph is also a directed acyclic graph. At step 406, partition generator 120 initiates the traversal of nodes included in the subgraph identified at step 404. In one embodiment, partition generator 120 traverses the subgraph starting from a root node of the subgraph and recursively visiting predecessors of the root node.

At step 408, partition generator 120 accumulates any fusable nodes to a common partition. In one embodiment, a “fusable” node corresponds to a pointwise operation, such as a unary or binary operation, where the value of each element of a result tensor depends on the value of a single element of each input tensor. Sin, cos, tan, exp, and log are examples of unary pointwise operations. Add, subtract, multiple, divide are examples of binary pointwise operations. Multiple pointwise operations corresponding to multiple fusable nodes may be performed by one kernel.

At step 410, partition generator 120 determines whether a non-fusable node has been reached. In one embodiment, a “non-fusable” node corresponds to an operation where the value of one or more elements in a result tensor depends on the value of multiple elements of each input tensor. Matrix-vector-multiply, matrix-matrix-multiply, convolution, and reduction are examples of such operations. In another embodiment, a non-fusable node corresponds to a pointwise operation that cannot be combined with any operations associated with any adjacent nodes. For example, node 222 of FIGS. 2A-2B corresponds to a pointwise operation (transpose) that nonetheless cannot be fused with any operations associated with any adjacent nodes. An operation corresponding to a non-fusable node may be performed by a dedicated kernel derived from a library, such as the cuBLAS or cuDNN libraries, for example.

If partition generator 120 determines at step 410 that a non-fusable node has been reached, then the method proceeds to step 412. At step 412, partition generator 120 assigns the non-fusable node identified at step 410 to a dedicated partition. For example, partition generator 120 could assign node 222 shown in FIGS. 2A-2B and mentioned above to partition 250. If partition generator 120 determines at step 410 that a non-fusable node has not been reached, then the method skips step 412 and proceeds to step 414.

At step 414, partition generator 120 determines whether additional nodes are included in the subgraph identified at step 404. In one embodiment, partition generator 120 recursively visits successive nodes in the subgraph by traversing predecessors of previously traversed nodes. If partition generator 120 determines at step 414 that the subgraph includes additional nodes, then the method returns to step 406 and proceeds as described above. Otherwise, if partition generator 120 determines at step 406 that the subgraph does not include additional nodes, then the method proceeds to step 416.

At step 416, partition generator 120 determines whether additional nodes are included in the graph generated at step 402. In one embodiment, upon completing the traversal of the subgraph in the manner described above, partition generator 120 may return to a root node of the graph and then identify a predecessor of the root node that is included in a different subgraph. If partition generator 120 determines at step 416 that the graph includes additional nodes, then the method returns to step 404 and proceeds as described above. Otherwise, if partition generator 120 determines at step 416 that the graph does not include additional nodes, then the method proceeds to step 418.

At step 418, kernel generator 130 within compiler 100 configures a sequence of kernels for execution on a parallel processor based on the partitions generated via steps 406, 408, 410, 412, 414, and 416. In one embodiment, kernel generator 130 configures a different kernel for each of the partitions generated via the above steps. The kernels generated in this fashion can then be executed by parallel processor 140 to perform the operations set forth in the program code in an accelerated manner and with efficient memory utilization.

### Example Hardware Architecture

FIG. 5 is a block diagram illustrating a computer system 500 configured to implement one or more aspects of various embodiments. In some embodiments, computer system 500 is a server machine operating in a data center or a cloud computing environment that provides scalable computing resources as a service over a network. In one embodiment, compiler 100 and/or kernels 132 execute on one or more processors included in computer system 500.

In various embodiments, computer system 500 includes, without limitation, a central processing unit (CPU) 502 and a system memory 504 coupled to a parallel processing subsystem 512 via a memory bridge 505 and a communication path 513. Memory bridge 505 is further coupled to an I/O (input/output) bridge 507 via a communication path 506, and I/O bridge 507 is, in turn, coupled to a switch 516.

In one embodiment, I/O bridge 507 is configured to receive user input information from optional input devices 508, such as a keyboard or a mouse, and forward the input information to CPU 502 for processing via communication path 506 and memory bridge 505. In some embodiments, computer system 500 may be a server machine in a cloud computing environment. In such embodiments, computer system 500 may not have input devices 508. Instead, computer system 500 may receive equivalent input information by receiving commands in the form of messages transmitted over a network and received via the network adapter 518. In one embodiment, switch 516 is configured to provide connections between I/O bridge 507 and other components of the computer system 500, such as a network adapter 518 and various add-in cards 520 and 521.

In one embodiment, I/O bridge 507 is coupled to a system disk 514 that may be configured to store content and applications and data for use by CPU 502 and parallel processing subsystem 512. In one embodiment, system disk 514 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 507 as well.

In various embodiments, memory bridge 505 may be a Northbridge chip, and I/O bridge 507 may be a Southbridge chip. In addition, communication paths 506 and 513, as well as other communication paths within computer system 500, may be implemented using any technically suitable protocols, including, without limitation, AGP (Accelerated Graphics Port), HyperTransport, or any other bus or point-to-point communication protocol known in the art.

In some embodiments, parallel processing subsystem 512 comprises a graphics subsystem that delivers pixels to an optional display device 510 that may be any conventional cathode ray tube, liquid crystal display, light-emitting diode display, or the like. In such embodiments, the parallel processing subsystem 512 incorporates circuitry optimized for graphics and video processing, including, for example, video output circuitry. As described in greater detail below in conjunction with FIGS. 8 and 9, such circuitry may be incorporated across one or more parallel processing units (PPUs), also referred to herein as parallel processors, included within parallel processing subsystem 512. In other embodiments, the parallel processing subsystem 512 incorporates circuitry optimized for general purpose and/or compute processing. Again, such circuitry may be incorporated across one or more PPUs included within parallel processing subsystem 512 that are configured to perform such general purpose and/or compute operations. In yet other embodiments, the one or more PPUs included within parallel processing subsystem 512 may be configured to perform graphics processing, general purpose processing, and compute processing operations. System memory 504 includes at least one device driver configured to manage the processing operations of the one or more PPUs within parallel processing subsystem 512.

In various embodiments, parallel processing subsystem 512 may be integrated with one or more of the other elements of FIG. 5 to form a single system. For example, parallel processing subsystem 512 may be integrated with CPU 502 and other connection circuitry on a single chip to form a system on chip (SoC).

In one embodiment, CPU 502 is the master processor of computer system 500, controlling and coordinating operations of other system components. In one embodiment, CPU 502 issues commands that control the operation of PPUs. In some embodiments, communication path 513 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 502, and the number of parallel processing subsystems 512, may be modified as desired. For example, in some embodiments, system memory 504 could be connected to CPU 502 directly rather than through memory bridge 505, and other devices would communicate with system memory 504 via memory bridge 505 and CPU 502. In other embodiments, parallel processing subsystem 512 may be connected to I/O bridge 507 or directly to CPU 502, rather than to memory bridge 505. In still other embodiments, I/O bridge 507 and memory bridge 505 may be integrated into a single chip instead of existing as one or more discrete devices. Lastly, in certain embodiments, one or more components shown in FIG. 5 may not be present. For example, switch 516 could be eliminated, and network adapter 518 and add-in cards 520, 521 would connect directly to I/O bridge 507.

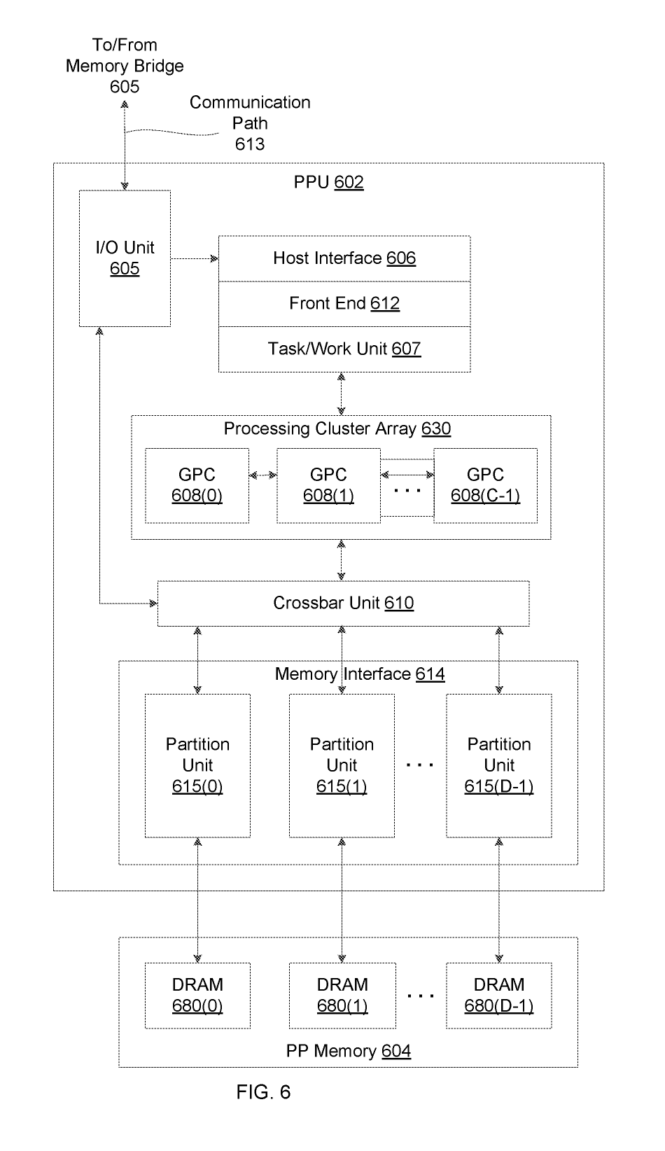

FIG. 6 is a block diagram of a parallel processing unit (PPU) 602 included in the parallel processing subsystem 512 of FIG. 5, according to various embodiments. Although FIG. 6 depicts one PPU 602, as indicated above, parallel processing subsystem 512 may include any number of PPUs 602. As shown, PPU 602 is coupled to a local parallel processing (PP) memory 604. PPU 602 and PP memory 604 may be implemented using one or more integrated circuit devices, such as programmable processors, application specific integrated circuits (ASICs), or memory devices, or in any other technically feasible fashion.

In some embodiments, PPU 602 comprises a graphics processing unit (GPU) that may be configured to implement a graphics rendering pipeline to perform various operations related to generating pixel data based on graphics data supplied by CPU 502 and/or system memory 504. When processing graphics data, PP memory 604 can be used as graphics memory that stores one or more conventional frame buffers and, if needed, one or more other render targets as well. Among other things, PP memory 604 may be used to store and update pixel data and deliver final pixel data or display frames to an optional display device 510 for display. In some embodiments, PPU 602 also may be configured for general-purpose processing and compute operations. In some embodiments, computer system 500 may be a server machine in a cloud computing environment. In such embodiments, computer system 500 may not have a display device 510. Instead, computer system 500 may generate equivalent output information by transmitting commands in the form of messages over a network via the network adapter 518.

In some embodiments, CPU 502 is the master processor of computer system 500, controlling and coordinating operations of other system components. In one embodiment, CPU 502 issues commands that control the operation of PPU 602. In some embodiments, CPU 502 writes a stream of commands for PPU 602 to a data structure (not explicitly shown in either FIG. 5 or FIG. 6) that may be located in system memory 504, PP memory 604, or another storage location accessible to both CPU 502 and PPU 602. A pointer to the data structure is written to a command queue, also referred to herein as a pushbuffer, to initiate processing of the stream of commands in the data structure. In one embodiment, the PPU 602 reads command streams from the command queue and then executes commands asynchronously relative to the operation of CPU 502. In embodiments where multiple pushbuffers are generated, execution priorities may be specified for each pushbuffer by an application program via device driver to control scheduling of the different pushbuffers.

In one embodiment, PPU 602 includes an I/O (input/output) unit 605 that communicates with the rest of computer system 500 via the communication path 513 and memory bridge 505. In one embodiment, I/O unit 605 generates packets (or other signals) for transmission on communication path 513 and also receives all incoming packets (or other signals) from communication path 513, directing the incoming packets to appropriate components of PPU 602. For example, commands related to processing tasks may be directed to a host interface 606, while commands related to memory operations (e.g., reading from or writing to PP memory 604) may be directed to a crossbar unit 610. In one embodiment, host interface 606 reads each command queue and transmits the command stream stored in the command queue to a front end 612.

As mentioned above in conjunction with FIG. 5, the connection of PPU 602 to the rest of computer system 500 may be varied. In some embodiments, parallel processing subsystem 512, which includes at least one PPU 602, is implemented as an add-in card that can be inserted into an expansion slot of computer system 500. In other embodiments, PPU 602 can be integrated on a single chip with a bus bridge, such as memory bridge 505 or I/O bridge 507. Again, in still other embodiments, some or all of the elements of PPU 602 may be included along with CPU 502 in a single integrated circuit or system of chip (SoC).

In one embodiment, front end 612 transmits processing tasks received from host interface 606 to a work distribution unit (not shown) within task/work unit 607. In one embodiment, the work distribution unit receives pointers to processing tasks that are encoded as task metadata (TMD) and stored in memory. The pointers to TMDs are included in a command stream that is stored as a command queue and received by the front end unit 612 from the host interface 606. Processing tasks that may be encoded as TMDs include indices associated with the data to be processed as well as state parameters and commands that define how the data is to be processed. For example, the state parameters and commands could define the program to be executed on the data. Also for example, the TMD could specify the number and configuration of the set of CTAs. Generally, each TMD corresponds to one task. The task/work unit 607 receives tasks from the front end 612 and ensures that GPCs 608 are configured to a valid state before the processing task specified by each one of the TMDs is initiated. A priority may be specified for each TMD that is used to schedule the execution of the processing task. Processing tasks also may be received from the processing cluster array 630. Optionally, the TMD may include a parameter that controls whether the TMD is added to the head or the tail of a list of processing tasks (or to a list of pointers to the processing tasks), thereby providing another level of control over execution priority.

In one embodiment, PPU 602 implements a highly parallel processing architecture based on a processing cluster array 630 that includes a set of C general processing clusters (GPCs) 608, where C 1. Each GPC 608 is capable of executing a large number (e.g., hundreds or thousands) of threads concurrently, where each thread is an instance of a program. In various applications, different GPCs 608 may be allocated for processing different types of programs or for performing different types of computations. The allocation of GPCs 608 may vary depending on the workload arising for each type of program or computation.

In one embodiment, memory interface 614 includes a set of D of partition units 615, where D≥1. Each partition unit 615 is coupled to one or more dynamic random access memories (DRAMs) 620 residing within PPM memory 604. In some embodiments, the number of partition units 615 equals the number of DRAMs 620, and each partition unit 615 is coupled to a different DRAM 620. In other embodiments, the number of partition units 615 may be different than the number of DRAMs 620. Persons of ordinary skill in the art will appreciate that a DRAM 620 may be replaced with any other technically suitable storage device. In operation, various render targets, such as texture maps and frame buffers, may be stored across DRAMs 620, allowing partition units 615 to write portions of each render target in parallel to efficiently use the available bandwidth of PP memory 604.

In one embodiment, a given GPC 608 may process data to be written to any of the DRAMs 620 within PP memory 604. In one embodiment, crossbar unit 610 is configured to route the output of each GPC 608 to the input of any partition unit 615 or to any other GPC 608 for further processing. GPCs 608 communicate with memory interface 614 via crossbar unit 610 to read from or write to various DRAMs 620. In some embodiments, crossbar unit 610 has a connection to I/O unit 605, in addition to a connection to PP memory 604 via memory interface 614, thereby enabling the processing cores within the different GPCs 608 to communicate with system memory 504 or other memory not local to PPU 602. In the embodiment of FIG. 6, crossbar unit 610 is directly connected with I/O unit 605. In various embodiments, crossbar unit 610 may use virtual channels to separate traffic streams between the GPCs 608 and partition units 615.

In one embodiment, GPCs 608 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 602 is configured to transfer data from system memory 504 and/or PP memory 604 to one or more on-chip memory units, process the data, and write result data back to system memory 504 and/or PP memory 604. The result data may then be accessed by other system components, including CPU 502, another PPU 602 within parallel processing subsystem 512, or another parallel processing subsystem 512 within computer system 500.

In one embodiment, any number of PPUs 602 may be included in a parallel processing subsystem 512. For example, multiple PPUs 602 may be provided on a single add-in card, or multiple add-in cards may be connected to communication path 513, or one or more of PPUs 602 may be integrated into a bridge chip. PPUs 602 in a multi-PPU system may be identical to or different from one another. For example, different PPUs 602 might have different numbers of processing cores and/or different amounts of PP memory 604. In implementations where multiple PPUs 602 are present, those PPUs may be operated in parallel to process data at a higher throughput than is possible with a single PPU 602. Systems incorporating one or more PPUs 602 may be implemented in a variety of configurations and form factors, including, without limitation, desktops, laptops, handheld personal computers or other handheld devices, servers, workstations, game consoles, embedded systems, and the like.

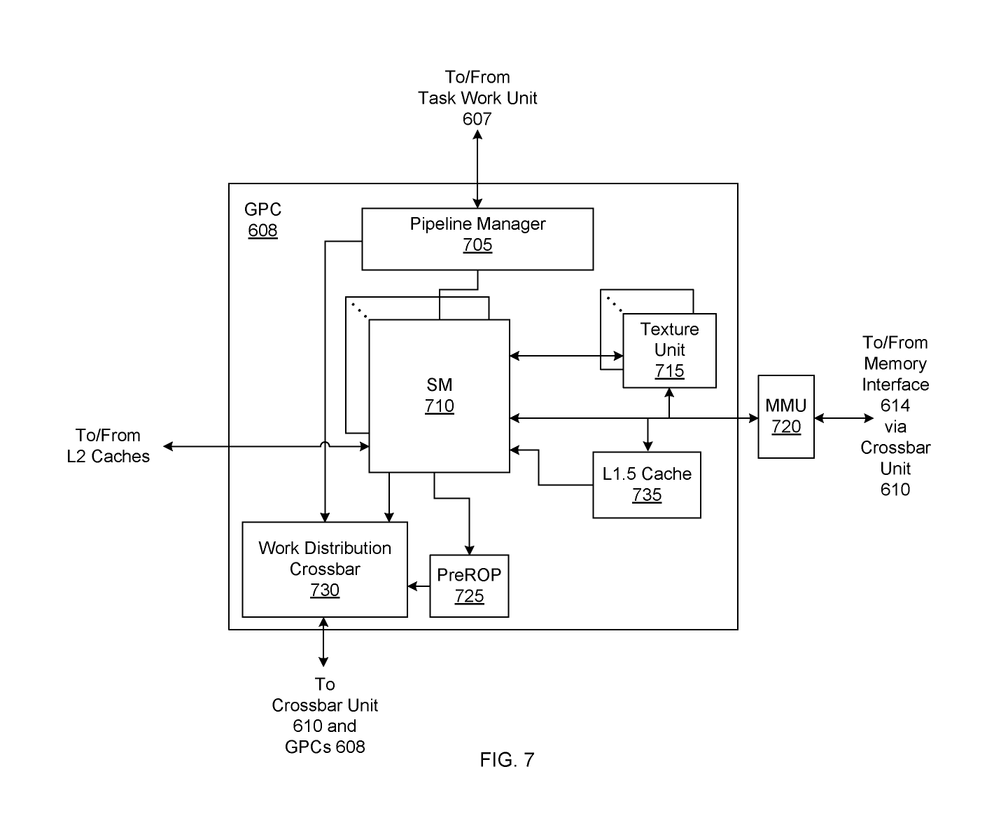

FIG. 7 is a block diagram of a general processing cluster (GPC) 608 included in the parallel processing unit (PPU) 602 of FIG. 6, according to various embodiments. As shown, the GPC 608 includes, without limitation, a pipeline manager 705, one or more texture units 715, a preROP unit 725, a work distribution crossbar 730, and an L1.5 cache 735.

In one embodiment, GPC 608 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 608. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

In one embodiment , operation of GPC 608 is controlled via a pipeline manager 705 that distributes processing tasks received from a work distribution unit (not shown) within task/work unit 607 to one or more streaming multiprocessors (SMs) 710. Pipeline manager 705 may also be configured to control a work distribution crossbar 730 by specifying destinations for processed data output by SMs 710.

In various embodiments, GPC 608 includes a set of M of SMs 710, where M 1. Also, each SM 710 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 710 may be provided. In various embodiments, the functional execution units may be configured to support a variety of different operations including integer and floating point arithmetic (e.g., addition and multiplication), comparison operations, Boolean operations (AND, OR, 50R), bit-shifting, and computation of various algebraic functions (e.g., planar interpolation and trigonometric, exponential, and logarithmic functions, etc.). Advantageously, the same functional execution unit can be configured to perform different operations.

In various embodiments, each SM 710 includes multiple processing cores. In one embodiment, the SM 710 includes a large number (e.g., 128, etc.) of distinct processing cores. Each core may include a fully-pipelined, single-precision, double-precision, and/or mixed precision processing unit that includes a floating point arithmetic logic unit and an integer arithmetic logic unit. In one embodiment, the floating point arithmetic logic units implement the IEEE 754-2008 standard for floating point arithmetic. In one embodiment, the cores include 64 single-precision (32-bit) floating point cores, 64 integer cores, 32 double-precision (64-bit) floating point cores, and 8 tensor cores.

In one embodiment, tensor cores configured to perform matrix operations, and, in one embodiment, one or more tensor cores are included in the cores. In particular, the tensor cores are configured to perform deep learning matrix arithmetic, such as convolution operations for neural network training and inferencing. In one embodiment, each tensor core operates on a 4×4 matrix and performs a matrix multiply and accumulate operation D=A×B+C, where A, B, C, and D are 4×4 matrices.

In one embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use tensor cores from a CUDA-C++ program. At the CUDA level, the warp-level interface assumes 16×16 size matrices spanning all 32 threads of the warp.

Neural networks rely heavily on matrix math operations, and complex multi-layered networks require tremendous amounts of floating-point performance and bandwidth for both efficiency and speed. In various embodiments, with thousands of processing cores, optimized for matrix math operations, and delivering tens to hundreds of TFLOPS of performance, the SMs 710 provide a computing platform capable of delivering performance required for deep neural network-based artificial intelligence and machine learning applications.

In various embodiments, each SM 710 may also comprise multiple special function units (SFUs) that perform special functions (e.g., attribute evaluation, reciprocal square root, and the like). In one embodiment, the SFUs may include a tree traversal unit configured to traverse a hierarchical tree data structure. In one embodiment, the SFUs may include texture unit configured to perform texture map filtering operations. In one embodiment, the texture units are configured to load texture maps (e.g., a 2D array of texels) from memory and sample the texture maps to produce sampled texture values for use in shader programs executed by the SM. In various embodiments, each SM 710 also comprises multiple load/store units (LSUs) that implement load and store operations between the shared memory/L1 cache and register files internal to the SM 710.

In one embodiment, each SM 710 is configured to process one or more thread groups. As used herein, a “thread group” or “warp” refers to a group of threads concurrently executing the same program on different input data, with one thread of the group being assigned to a different execution unit within an SM 710. A thread group may include fewer threads than the number of execution units within the SM 710, in which case some of the execution may be idle during cycles when that thread group is being processed. A thread group may also include more threads than the number of execution units within the SM 710, in which case processing may occur over consecutive clock cycles. Since each SM 710 can support up to G thread groups concurrently, it follows that up to G*M thread groups can be executing in GPC 608 at any given time.

Additionally, in one embodiment, a plurality of related thread groups may be active (in different phases of execution) at the same time within an SM 710. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 710, and m is the number of thread groups simultaneously active within the SM 710. In some embodiments, a single SM 710 may simultaneously support multiple CTAs, where such CTAs are at the granularity at which work is distributed to the SMs 710.

In one embodiment, each SM 710 contains a level one (L1) cache or uses space in a corresponding L1 cache outside of the SM 710 to support, among other things, load and store operations performed by the execution units. Each SM 710 also has access to level two (L2) caches (not shown) that are shared among all GPCs 608 in PPU 602. The L2 caches may be used to transfer data between threads. Finally, SMs 710 also have access to off-chip “global” memory, which may include PP memory 604 and/or system memory 504. It is to be understood that any memory external to PPU 602 may be used as global memory. Additionally, as shown in FIG. 7, a level one-point-five (L1.5) cache 735 may be included within GPC 608 and configured to receive and hold data requested from memory via memory interface 614 by SM 710. Such data may include, without limitation, instructions, uniform data, and constant data. In embodiments having multiple SMs 710 within GPC 608, the SMs 710 may beneficially share common instructions and data cached in L1.5 cache 735.

In one embodiment, each GPC 608 may have an associated memory management unit (MMU) 720 that is configured to map virtual addresses into physical addresses. In various embodiments, MMU 720 may reside either within GPC 608 or within the memory interface 614. The MMU 720 includes a set of page table entries (PTEs) used to map a virtual address to a physical address of a tile or memory page and optionally a cache line index. The MMU 720 may include address translation lookaside buffers (TLB) or caches that may reside within SMs 710, within one or more L1 caches, or within GPC 608.

In one embodiment, in graphics and compute applications, GPC 608 may be configured such that each SM 710 is coupled to a texture unit 715 for performing texture mapping operations, such as determining texture sample positions, reading texture data, and filtering texture data.

In one embodiment, each SM 710 transmits a processed task to work distribution crossbar 730 in order to provide the processed task to another GPC 608 for further processing or to store the processed task in an L2 cache (not shown), parallel processing memory 604, or system memory 504 via crossbar unit 610. In addition, a pre-raster operations (preROP) unit 725 is configured to receive data from SM 710, direct data to one or more raster operations (ROP) units within partition units 615, perform optimizations for color blending, organize pixel color data, and perform address translations.

It will be appreciated that the architecture described herein is illustrative and that variations and modifications are possible. Among other things, any number of processing units, such as SMs 710, texture units 715, or preROP units 725, may be included within GPC 608. Further, as described above in conjunction with FIG. 6, PPU 602 may include any number of GPCs 608 that are configured to be functionally similar to one another so that execution behavior does not depend on which GPC 608 receives a particular processing task. Further, each GPC 608 operates independently of the other GPCs 608 in PPU 602 to execute tasks for one or more application programs.

In sum, various embodiments include a compiler that generates an accelerated version of a serial computer program that can be executed on a parallel processor. In one embodiment, the compiler analyzes the serial computer program and generates a graph of nodes connected by edges. Each node corresponds to an operation or a value set forth in the serial computer program. Each incoming edge corresponds to an operand that is specified or generated in the serial computer program. The compiler partitions the graph of nodes into two different types of partitions.

In one embodiment, a first type of partition includes one or more nodes that correspond to one or more pointwise operations, and a second type of partition includes one node that corresponds to one operation that is performed efficiently via a library. For a partition having the first type, the compiler generates a kernel that can perform all of the pointwise operations on the parallel processor without needing to move data into and out of register memory excessively. For a partition having the second type, the compiler generates a library call to invoke execution of a kernel that can perform the operation associated with the partition. In the manner described above, in various embodiments the compiler configures a sequence of kernels that can be executed on the parallel processor to perform the various operations associated with the computer program in an accelerated fashion.

At least one technological advantage of the techniques described herein is that a serial computer program designed for serial execution can be automatically converted into a parallel computer program that is optimized for parallel execution. Accordingly, serial computer programs can quickly and easily be accelerated via parallel processing hardware. Another technological advantage is that specialized knowledge of parallel processors is not needed. These technological advantages represent multiple technological advancements relative to prior art approaches.

1. Some embodiments include a computer-implemented method comprising partitioning a plurality of operations included in program code into a plurality of partitions based on a graph representation of the program code, wherein each partition includes a different set of operations from the plurality of operations, and for each partition in the plurality of partitions, configuring a separate kernel for executing the set of operations included in the partition.

2. The computer-implemented method of clause 1, wherein a first partition included in the plurality of partitions includes at least two nodes that correspond to pointwise operations.

3. The computer-implemented method of any of clauses 1-2, further comprising generating the first partition by determining that a first node of the at least two nodes corresponds to a first pointwise operation included in the plurality of operations, adding the first node to the first partition, determining that a second node of the at least two nodes is a predecessor of the first node, determining that the second node corresponds to a second pointwise operation included in the plurality of operations, and adding the second node to the first partition.

4. The computer-implemented method of any of clauses 1-3, wherein a first kernel is configured for the first partition by combining the first pointwise operation with the second pointwise operation.

5. The computer-implemented method of any of clauses 1-4, wherein the first kernel is executed by a parallel processor to perform the first pointwise operation and the second pointwise operation, and wherein the parallel processor performs a read operation and a write operation when executing the first kernel.

6. The computer-implemented method of any of clauses 1-5, wherein a first partition included in the plurality of partitions includes a first node that corresponds to a first operation included in the plurality of operations.

7. The computer-implemented method of any of clauses 1-6, further comprising generating the first partition by determining that a first kernel included in a library of kernels includes an implementation of the first operation, and adding the first node to the first partition, wherein additional nodes are not added to the first partition.

8. The computer-implemented method of any of clauses 1-7, wherein the graph representation comprises a directed acyclic graph.

9. The computer-implemented method of any of clauses 1-8, wherein none of the partitions included in the plurality of partitions has cyclic dependencies on other partitions included in the plurality of partitions.

10. The computer-implemented method of any of clauses 1-9, further comprising causing a parallel processor to execute a plurality of kernels associated with the plurality of partitions according to a sequence that is associated with the plurality of partitions.

11. The computer-implemented method of any of clauses 1-10, further comprising causing a parallel processor to execute one of the separate kernels to perform at least one of the plurality of operations in parallel.

12. The computer-implemented method of any of clauses 1-11, wherein one of the separate kernels is configured by combining a subset of the plurality of operations.

13. Some embodiments include a computer-implemented method, comprising identifying one or more operations of a computer program to perform in parallel, wherein each of the one or more operations corresponds to a different one or more nodes in a sequence of connected graph nodes, generating a kernel to perform the one or more operations in parallel, and causing the kernel to perform the one or more operations in parallel.

14. The computer-implemented method of clause 13, wherein a first partition included in the plurality of partitions includes a first node associated with a first operation where each output element from the first node corresponds to one input element to the first node and a second node where each output element from the second node corresponds to one input element to the second node.

15. The computer-implemented method of any of clauses 13-14, wherein a first partition included in the plurality of partitions includes a first node associated with a first operation where each output element from the first node corresponds to multiple input elements to the first node and a second node where each output element from the second node corresponds to multiple input elements to the second node.

16. The computer-implemented method of any of clauses 13-15, wherein the kernel is executed by a parallel processor to perform the one or more operations, and wherein the parallel processor performs a read operation and a write operation when executing the kernel.

17. The computer-implemented method of any of clauses 13-16, wherein the sequence of connected graph nodes comprises a directed acyclic graph.

18. Some embodiments include a system, comprising a memory storing one or more instructions, and a processor that executes the instructions to at least partition a plurality of operations included in program code into a plurality of partitions based on a graph representation of the program code, wherein each partition includes a different set of operations from the plurality of operations, and for each partition in the plurality of partitions, configuring a separate kernel for executing the set of operations included in the partition.

19. The system of clause 18, further comprising a parallel processor that executes each separate kernel to perform the plurality of operations.

20. The system of any of clauses 18-19, wherein one of the separate kernels is configured by combining a subset of the plurality of operations.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method comprising:
partitioning a plurality of operations included in program code into a plurality of partitions based on a graph representation of the program code, wherein each partition includes a different set of operations from the plurality of operations; and
for each partition in the plurality of partitions, configuring a separate kernel for executing the set of operations included in the partition.

2. The computer-implemented method of claim 1, wherein a first partition included in the plurality of partitions includes at least two nodes that correspond to pointwise operations.

3. The computer-implemented method of claim 2, further comprising generating the first partition by:
determining that a first node of the at least two nodes corresponds to a first pointwise operation included in the plurality of operations;
adding the first node to the first partition;
determining that a second node of the at least two nodes is a predecessor of the first node;
determining that the second node corresponds to a second pointwise operation included in the plurality of operations; and
adding the second node to the first partition.

4. The computer-implemented method of claim 3, wherein a first kernel is configured for the first partition by combining the first pointwise operation with the second pointwise operation.

5. The computer-implemented method of claim 4, wherein the first kernel is executed by a parallel processor to perform the first pointwise operation and the second pointwise operation, and wherein the parallel processor performs a read operation and a write operation when executing the first kernel.

6. The computer-implemented method of claim 1, wherein a first partition included in the plurality of partitions includes a first node that corresponds to a first operation included in the plurality of operations.

7. The computer-implemented method of claim 6, further comprising generating the first partition by:
determining that a first kernel included in a library of kernels includes an implementation of the first operation; and
adding the first node to the first partition, wherein additional nodes are not added to the first partition.

8. The computer-implemented method of claim 1, wherein the graph representation comprises a directed acyclic graph.

9. The computer-implemented method of claim 1, wherein none of the partitions included in the plurality of partitions has cyclic dependencies on other partitions included in the plurality of partitions.

10. The computer-implemented method of claim 1, further comprising causing a parallel processor to execute a plurality of kernels associated with the plurality of partitions according to a sequence that is associated with the plurality of partitions.

11. The computer-implemented method of claim 1, further comprising causing a parallel processor to execute one of the separate kernels to perform at least one of the plurality of operations in parallel.

12. The computer-implemented method of claim 1, wherein one of the separate kernels is configured by combining a subset of the plurality of operations.

13. A computer-implemented method, comprising:
identifying one or more operations of a computer program to perform in parallel, wherein each of the one or more operations corresponds to a different one or more nodes in a sequence of connected graph nodes;
generating a kernel to perform the one or more operations in parallel; and
causing the kernel to perform the one or more operations in parallel.

14. The computer-implemented method of claim 13, wherein a first partition included in the plurality of partitions includes a first node associated with a first operation where each output element from the first node corresponds to one input element to the first node and a second node where each output element from the second node corresponds to one input element to the second node.

15. The computer-implemented method of claim 13, wherein a first partition included in the plurality of partitions includes a first node associated with a first operation where each output element from the first node corresponds to multiple input elements to the first node and a second node where each output element from the second node corresponds to multiple input elements to the second node.

16. The computer-implemented method of claim 13, wherein the kernel is executed by a parallel processor to perform the one or more operations, and wherein the parallel processor performs a read operation and a write operation when executing the kernel.

17. The computer-implemented method of claim 13, wherein the sequence of connected graph nodes comprises a directed acyclic graph.

18. A system, comprising:
a memory storing one or more instructions; and
a processor that executes the instructions to at least:
partition a plurality of operations included in program code into a plurality of partitions based on a graph representation of the program code,
wherein each partition includes a different set of operations from the plurality of operations, and
for each partition in the plurality of partitions, configuring a separate kernel for executing the set of operations included in the partition.

19. The system of claim 18, further comprising a parallel processor that executes each separate kernel to perform the plurality of operations.

20. The system of claim 19, wherein one of the separate kernels is configured by combining a subset of the plurality of operations.
